(19) United States
(12) Patent Application Publication
(10) Pub. No.: US 2025/0002188 A1
(43) Pub. Date: Jan. 2, 2025

(54) PROCESS AND APPARATUS FOR SHAPING A BOX BY WRAPPING AROUND

(71) Applicant: R.A JONES & CO., Covington, KY (US)

(72) Inventors: Andrea BIONDI, Bologna (IT); Luca CAVAZZA, Bologna (IT); Enrico CAMPAGNOLI, Bologna (IT)

(21) Appl. No.: 18/711,555

(22) PCT Filed: Nov. 22, 2022
(86) PCT No.: PCT/IB2022/061298

§ 371 Date: May 17, 2024

(30) Foreign Application Priority Data
Nov. 24, 2021 (IT) 102021000029759

(51) Int. Cl. B65B 11/28; B65B 5/02; B65B 5/04; B65B 11/00; B65B 35/24; B65B 43/10

(52) U.S. Cl. CPC B65B 11/28; B65B 5/024; B65B 5/04; B65B 11/004; B65B 35/24; B65B 43/10

(57) ABSTRACT

A process and apparatus for shaping a box by wrapping around, wherein a blank is wrapped around a content to be packaged, including the steps of: conveying a content to be packaged onto an inlet transport plane, arranged horizontally, the content to be packaged being laid on said inlet transport plane; transferring the content to be packaged onto a shaping support which moves continuously along an annular path, on a portion of which the shaping support moves on a shaping plane; and wrapping a box around the content to be packaged while the shaping support moves on said shaping plane. The inlet transport plane, and the shaping plane are coplanar to reduce the stress on the final product during packaging.

The present invention relates to a process and apparatus for shaping a box by wrapping around.

The content of the following Patent Applications, by the Applicant is considered as herein fully incorporated:
Italian Patent Application No. 102021000029750 dated 24 Nov. 2021 titled “Metodo di confezionamento di articoli in scatole e dispositivo di confezionamento operante secondo tale metodo”;
Italian Patent Application No. 102021000029753 dated 24 Nov. 2021 titled “Metodo di confezionamento di articoli in scatole e dispositivo di confezionamento operante secondo tale metodo”;
Italian Patent Application No. 102021000029756 dated 24 Nov. 2021 titled “Apparato e Processo per 1a formazione in avvolgimento di una scatola”;
Italian Patent Application No. 102021000029759 dated 24 Nov. 2021 titled “Processo e Apparato per 1a formazione in avvolgimento di una scatola”;
Italian Patent Application No. 102021000029762 dated 24 Nov. 2021 titled “Dispositivo e metodo per il confezionamento di articoli in scatole”; and
Italian Patent Application No. 102021000029765 dated 24 Nov. 2021 titled “Metodo per operare su prodotti”.

The present invention preferably applies, though non-exclusively to the field of packaging articles, such as loose or granule products contained in flexible pouches or bags, whose shape is affected not only by the shape of the pouch or bag, but also by the amount and arrangement of the product therein. The content of the flexible pouch could in principle therefore relate to any product having an undefined shape, and it could therefore be liquid, or have a creamy or paste consistency. Such pouches or bags are in turn packaged inside boxes with a substantially square shape.

More specifically, non-exclusive examples of the aforesaid application may be found in the food industry, for packaging food in powder, granulate, and particulate form composed of discrete elements.

A non-exclusive example of use is represented by the packaging of products derived from flaked or granule cereals, also known as corn-flakes, which are usually marketed as breakfast products. They are generally made available in a box-shaped packaging which in turn contains a pouch made of flexible material that meets the specific packaging requirements of the product.

Hereinafter, reference will be made to this particular field, without losing generality.

Hereinafter, the term “pouch” will therefore be used to indicate the flexible portion of the final packaging, already filled with the relevant product in a predetermined amount and already sealed.

Hereinafter, the term “box” will be used to indicate the box intended to contain one or more of the aforesaid pouches, and any other products, accessories, or sheet elements to provide the end user with information on the content and how to consume it, promotional information and so on. It is formed by substantially rigid walls and is provided with a predefined shape, for exemplary purposes a square shape, i.e. with pairs of walls parallel to each other.

In particular, in the relevant technical field, packaging processes and apparatuses are known in which the box is obtained from a blank that is wrapped around the content to be packaged.

In this type of process, the product to be packaged is transported along a transport line, with a separating space between successive contents, a space that is exploited to insert a blank between the products that is wrapped around the target product, and is subsequently sealed, e.g. by gluing operations.

On the one hand, it is understood that, in order to increase the productivity of such a packaging apparatus, it may be envisaged to increase the transport speed of the content on the respective transport line. However, the increased speed might require a greater spacing between the contents, which in turn might nullify the effects of the increased speed.

On the other hand, the operations required to shape the box require a high level of care and precision, which could be hindered by any inertial movement of the content relative to the box while it is wrapped.

In fact, higher transport speeds may affect both the shape and position of the content, which, as explained above, does not have a precise shape and cannot be grasped with gripping systems which exert high pressures that might break the pouch, or damage its content.

In other words, it is required that possible higher transport speeds are compatible with a certain care in transfer and transport operations, which must also extend to the steps wherein the content is wrapped in the respective box, as it has not yet been completely sealed.

Considering, therefore, that the content in the pouch is not fastened to the box that is wrapped around it, it could move towards the outside of the box due to inertial effects caused by the movement of the content and the box, or damage both the product within the bag, reducing its intrinsic value, and the box during its shaping.

Therefore, the process of shaping a box by wrapping-around must be carried out in such a way that the inertial effects, determined by the transport of the content to be packaged both outside and inside the same box, are not detrimental to achieving maximum precision in shaping the box, which must therefore take on a predefined shape and be obtained in compliance with strict parameters, and do not damage the product contained in the pouches being packaged.

In the present disclosure, as well as in the accompanying claims, certain terms and expressions are deemed to have, unless otherwise expressly indicated, the meaning expressed in the following definitions.

Here and hereinafter, the term “content” or “content to be packaged” refers to an assembly consisting of one or more flexible pouches containing a loose product, i.e. without a shape of its own, provided in a liquid or paste form, in powder, granules, discrete particles and the like, the shape of which is at least to a certain extent variable and affected by the conditions of transport, the position of the product inside the pouch, the shape of a respective rigid container and the inertial effects to which the content and the respective product are subjected.

“Packaging” of one or more articles in a box means obtaining a box containing said one or more articles. Such packaging may be obtained by introducing one or more articles in an already shaped box or, preferably, may be obtained by shaping a box around the one or more articles to be contained.

“Blank” refers to a flat element, suitably die-cut, from which, by means of operations of folding and fixing the flaps, a box is obtained, i.e. a shaped sheet with a suitable material and thickness that is adapted to be wrapped by means of folding around a mandrel to shape a box.

“Transport plane” refers to a transport system in which the content to be packed and possibly the box are laid on a plane and are made to move on it, e.g. by the movement of the plane itself, which may consist of a sliding belt, a self-propelled support, a gripping element that grasps the content to be packaged and possibly the box by translating them so that they move sliding on a plane.

“Path” and “transfer path” refer to the trajectories that the content to be packaged and possibly the box follow as a result of their respective transport planes; they may be curvilinear or rectilinear, closed, and in particular annular, or open, extending between an entry end and an exit end.

“Shaping by wrapping-around” refers to a step of shaping a box which is performed by wrapping-around a flat blank, for exemplary purposes made of cardboard or chipboard, and in any case suitable for obtaining a box, around the content to be packaged, which in turn may be laid on a shaping support.

“Carousel” refers to an apparatus wherein a plurality of pieces of equipment rotate about a vertical axis, possibly mounted on a rotating drum or other mechanism which make the equipment perform a closed trajectory, in particular a substantially circular trajectory; wherein each piece of equipment, at each turn, receives one or more inlet articles, performs specific operations on said one or more articles, possibly modifying their configuration, and produces an output with said one or more modified articles.

“Shaping support” refers to a support, which may in particular be of the movable type, which ensures that the content is held in a predetermined position during the step of shaping by wrapping around.

“Mandrel” or “wrapping mandrel” refers to a special shaping support that, at least to a certain extent, wraps the content to be packaged around, and has rigid, pre-determinedly positioned, abutment elements around which the box is wrapped in such a way that its walls take on a pre-determined position.

“Gripping device” refers to a device capable of picking up the content to be packaged and possibly the box being picked up from one transport plane and placed on another transport plane.

“Shaping device” refers to a device in which the step of wrapping around the blank and shaping the box around the respective content takes place.

“Blank dispenser device” refers to a device that provides, into the aforesaid shaping device, individual blanks, each of which is intended to shape a box.

The Applicant noted that the speed in transferring the contents to be packaged during the packaging process thereof is crucial for the overall process economy, as high production volumes may be achieved with fewer packaging apparatuses.

Moreover, the Applicant noted that, in addition to the need to proceed with the highest possible speed, another important and unavoidable requirement is represented by the fragility of the content, thereby requiring a treatment so as not to damage either the pouch or the content therein, in order not to reduce the commercial value thereof.

The Applicant also verified that the increase in the aforesaid transport speeds could imply several difficulties in the process of shaping the box, which requires considerable precision in mating the flaps forming it.

The Applicant found that, in general, the extent of these errors tends to increase with both the aforesaid transverse dimensions and the aforesaid transport speeds, because the error mostly depends on mechanical clearances in the transport system, which cannot be removed and, on the contrary, allow the transport system to reach high speeds in the flow of the transported articles to be packaged.

The Applicant then ascertained the need to reduce the size of the packaging apparatuses, a reduction that could increase the complexity of the transport paths implemented during the shaping of the box, which complexity requires considerable care in predicting the consequences of the inertial effects on the contents and boxes.

However, the Applicant noted that size reduction may be implemented with special expedients, which still allow for high transport speeds, without nullifying the final result of the packaging process.

The Applicant, however, realised that the aforesaid expedients may relate to the course of the transport paths, which may be selected both to facilitate the shaping of the box and to avoid falling into the above-reported inconveniences.

The Applicant therefore perceived that the optimal transport paths are those providing for a substantial coplanarity in the different steps of transferring the content and its box from one step of the packaging process to another.

Finally, the Applicant found that this appropriately chosen coplanarity between steps significantly reduces any inertial effects caused by the adoption of transport speeds suitable for the requirements of general packaging operations, including a significant reduction in the damage caused in the loose product to be packaged.

In particular, the invention, in a first aspect thereof, relates to a process for shaping a box by wrapping around, wherein a blank is wrapped around a content to be packaged.

Preferably, such a process comprises a step wherein a content to be packaged is conveyed onto an inlet transport plane, which is arranged in a horizontal position.

Preferably, the content is placed on said inlet transport plane.

Preferably, such process comprises a further transfer step wherein the aforesaid content to be packaged is transferred onto a shaping support that moves continuously along an annular path, and, in particular, on a portion of that path the shaping support moves on the shaping plane.

Preferably, such process comprises an additional shaping step wherein a blank is wrapped around the content to be packaged while the shaping support moves on said shaping plane so as to shape a box.

Preferably the inlet transport plane and the shaping plane are coplanar.

Thanks to these features, the stress caused by the passage of the content from the entry path, determined by the inlet transport plane, to the shaping path is significantly reduced, so that the content and the product therein are not damaged.

It will also be noted that this solution, still thanks to the aforesaid features, is applicable to a very wide range of products to be packaged, as well as to the packaging of several bags in the same box.

The invention, in a second aspect thereof, relates to an apparatus for shaping a box by wrapping around.

Preferably, the aforesaid apparatus comprises an inlet transport plane that is arranged horizontally, onto which a content to be packaged is conveyed leaning thereon.

Preferably, the apparatus for shaping by wrapping around comprises an inlet transfer device to transfer the content from said inlet transport plane.

Preferably, the aforesaid apparatus further comprises a shaping device comprising one or more shaping supports, each movable continuously along an annular path defined by the shaping device itself.

Preferably, the above-mentioned shaping device further comprises a shaping plane of said annular path wherein the boxes are shaped by wrapping them onto a respective shaping support, which in turn is capable of receiving said content to be packaged by said inlet transfer device.

Preferably, the aforementioned apparatus further comprises a blank dispenser device, which delivers a respective blank at a respective shaping support in which said content has been transferred.

Preferably, in the apparatus according to the present solution, the inlet transport plane and the outlet shaping plane are coplanar.

As a result, thanks to these features the passage of the content in the box entry and shaping steps is such to minimise the inertial effects on both the content itself and those that might indirectly affect the box while being shaped.

In other words, keeping the content on a single plane prevents the product accommodated therein from spoiling, but also prevents it from taking on the wrong position, or interfering with the blanks in an inappropriate way.

In at least one of the aforesaid aspects, this solution may also include at least one of the following preferred features.

Preferably, said annular path is formed on a shaping carousel that comprises a vertical axis of rotation, minimising the size of the apparatus and simplifying its structure.

Preferably, in the aforesaid process, once the box shaping by wrapping around has been completed, an exit step is envisaged wherein the box and the content are transferred onto an outlet transport plane, arranged horizontally.

In this passage, the box is placed on said outlet transport plane, and the outlet transport plane and the shaping plane are coplanar with each other.

The inertial effects mentioned above are thereby minimised even in the exit step, wherein the box is partially shaped, and wherein the content could still escape from it, in the absence of means to hold it in place.

Preferably, and in this regard, the apparatus comprises an outlet transfer device, for transferring a box obtained on the shaping plane, and an outlet transport plane arranged horizontally, on which said box received by the outlet transfer device is conveyed leaning thereon.

Said shaping plane and said the outlet transport plane are therefore coplanar with each other.

Preferably, said annular path, which comprises said shaping plane, comprises a section in which the support follows a path in which, at the end of the shaping plane, it descends to a lower level and then rises again to the level of the shaping plane at an inlet thereof.

At that point in the ascent, it receives said content, while the transfer from the inlet transport plane to the shaping plane takes place on an inlet transfer plane coplanar to said inlet transport plane and shaping plane.

Such feature further minimises the consequences of the above-mentioned inertial effects.

In this regard, in the apparatus, said shaping support is made on a lift mechanism that is made to revolve by a carousel.

When the support receives the respective content from an inlet transfer device, the lift mechanism lifts said support to a shaping level that corresponds to said shaping plane and, when the box is transferred to the outlet transfer device, it lowers said support to a lower level.

Preferably, said support moves across the shaping plane at a predetermined speed that is substantially constant.

In addition, it is slowed down at said ascent in order to mate with said content.

This choice makes it possible to minimise any acceleration that might affect the content to be packaged.

Preferably, said inlet transport plane comprises an entry path along which said content moves, and first curvilinear transfer path, which joins a terminal end of said rectilinear entry path to said closed circular path at the ascent of the respective support.

This expedient prevents the content to be packaged from being affected by abrupt deviations that could compromise its stability.

Preferably, said entry path is rectilinear, simplifying the process geometries and allowing a stable and precise positioning of the content on it.

Preferably, at one terminal end of the shaping plane, the transfer from the shaping plane to the outlet transport plane takes place on an outlet transfer plane that is coplanar to said shaping plane and outlet transport plane.

This choice still allows to minimise any acceleration that might affect the content to be packaged.

Preferably, said inlet transport plane comprises an exit path along which said box moves, and a second curvilinear transfer path, which joins a terminal end of said closed circular path to said exit path.

This expedient still prevents the content to be packaged from being affected by abrupt deviations that could compromise its stability.

Preferably, this exit path is also rectilinear, simplifying the process geometries and allowing a stable and precise positioning of the box on it.

Preferably, said shaping support comprises a wrapping-around mandrel, which may be extracted at the outlet end of the annular path, still remaining integral with it and allows to shape the box in a more precise way.

Preferably, in the aforesaid apparatus, said inlet transport plane and said outlet transport plane are formed on respective entry and exit rectilinear conveyor belts.

It must be specified that some steps of the method described above may be independent of the order of execution reported. In addition, some steps may be optional. Furthermore, some steps of the method may be performed repetitively, or they may be performed in series or in parallel with other steps of the method.

This solution will be described hereinafter according to a preferred embodiment thereof, provided for illustrative and non-limiting purposes with reference to the accompanying drawings in which:

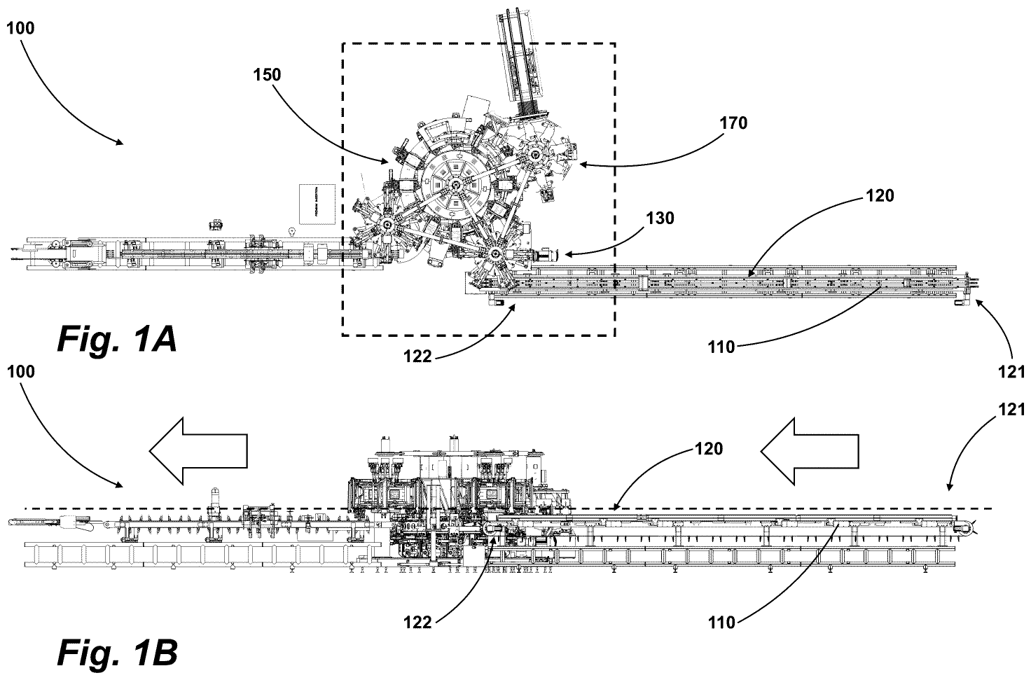

FIG. 1A shows an overall plan view of an embodiment of a packaging apparatus for shaping a box by wrapping around;

FIG. 1B shows an overall side view of the apparatus of FIG. 1A;

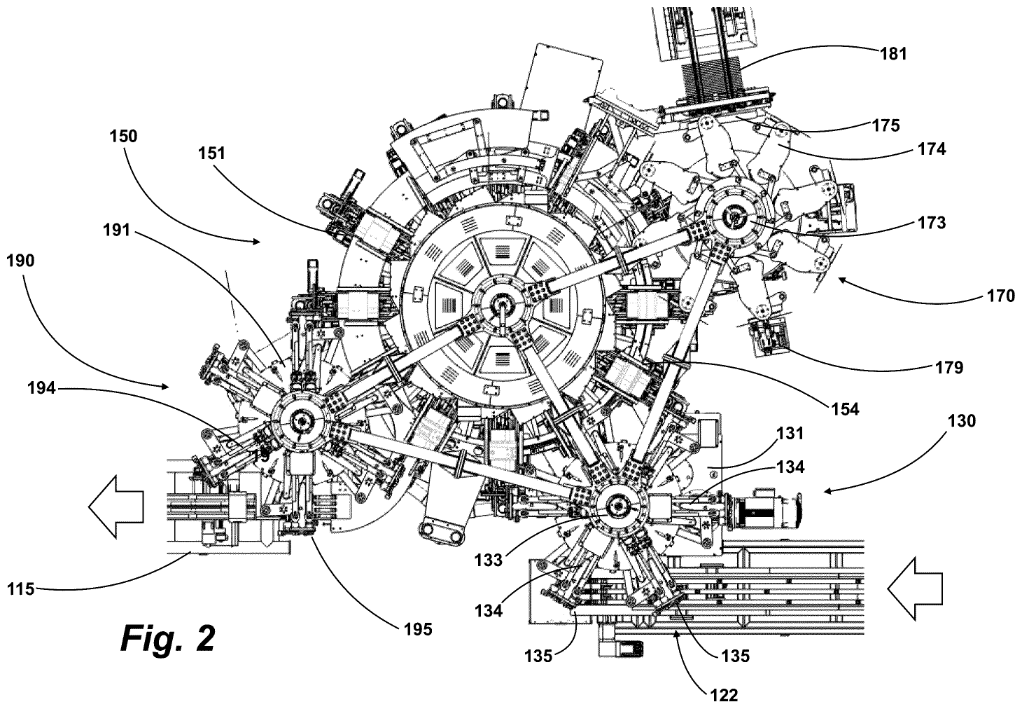

FIG. 2 shows a plan view of a portion of the apparatus of FIG. 1A, wherein the step of shaping a box by wrapping around takes place;

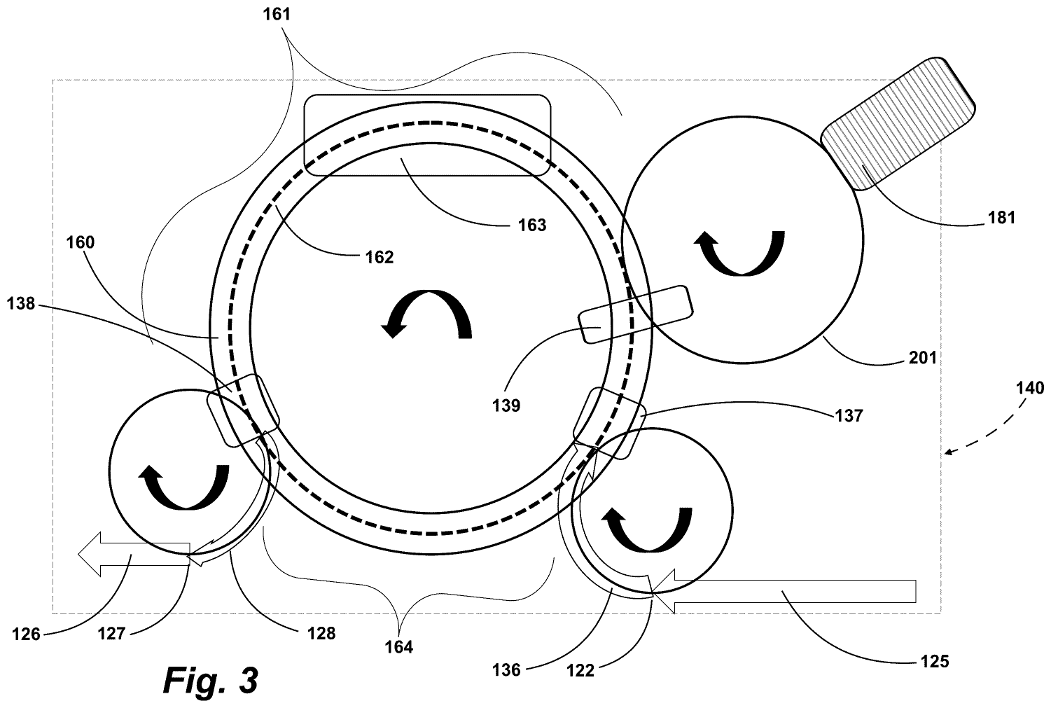

FIG. 3 shows a diagram illustrating the paths of the content to be packaged and the boxes in the portion of the apparatus of FIG. 2; and

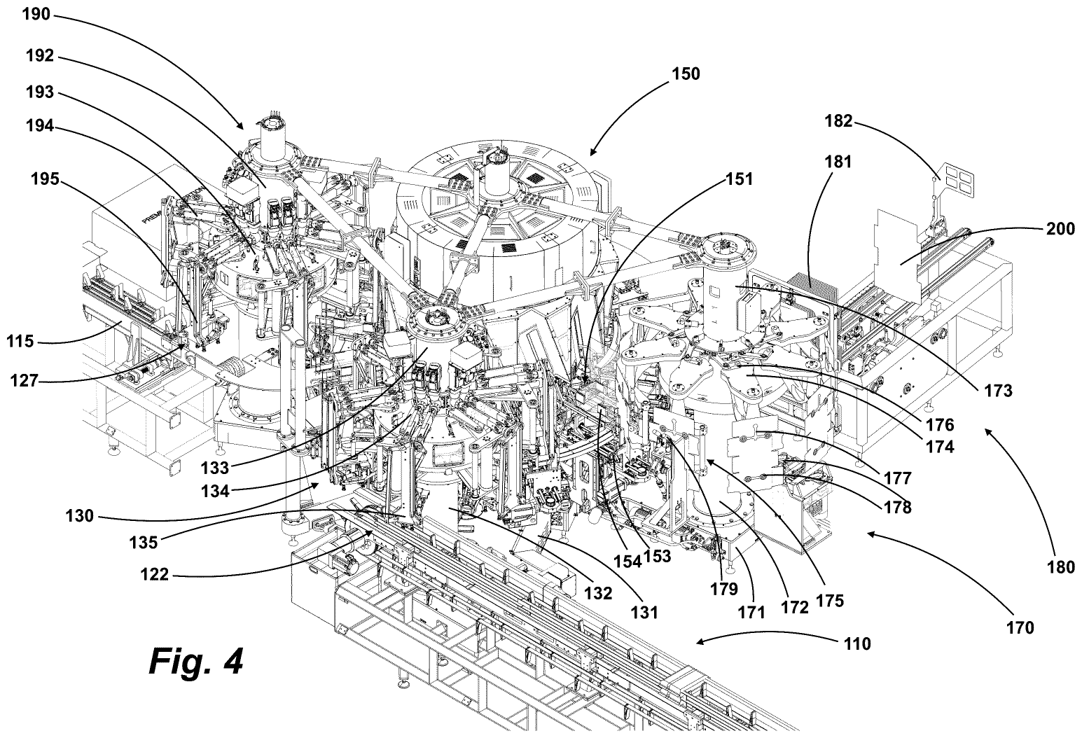

FIG. 4 shows a perspective view of the portion of the apparatus of FIG. 2.

In the enclosed Figures, number 100 globally denotes an apparatus for packaging articles to be packaged, i.e. in particular an apparatus for shaping a box by wrapping around a product to be packaged, which, in the present example, may consist of one or more flexible pouches, filled with predetermined amounts of products in the form of a discrete particulate consisting of granules and/or flakes and suitably sealed.

The apparatus 100 comprises a first transport device 110, consisting of a rectilinear conveyor belt on which the products to be packaged are conveyed, which in the present example consist of the above-described pouches, coming from the respective filling and sealing plant.

The first transport device 110 defines a transport plane 120, operating as an inlet transport plane on which the content to be packaged is laid, with the first transport device 110 conveying the content forward at a substantially constant speed on the inlet transport plane. Regarding the apparatus, the inlet transport plane defined in the first transport device 110 is arranged horizontally, and extends from a first loading end 121 of the first transport device 110 to a first unloading end 122 of the first transport device 110.

Thanks to the first transport device 110, a trajectory is defined on the inlet transport plane 120, which is followed by each content to be packaged, constituting a rectilinear and horizontally arranged entry path 125 (FIG. 3).

The aforesaid unloading end 122 is near, i.e. within range, of a first transfer device 130 which acts as an inlet transfer device: it is arranged to pick up a target product to be packaged, which moves on the inlet transport plane 120, in order to transfer it from there to a shaping device, indicated as a whole by 150, wherein a step of wrapping a box around is provided.

An inlet or outlet transfer device refers to a mechanism capable of grasping, by means of grippers and/or suction cups, an article and transporting it, by means of a self-propelled arm, possibly robotised, from a starting position to a final position.

The inlet transfer device 130 has a carousel structure: it comprises a first base 131, a first upright 132 extending vertically from said base 131 and having, at its top, a first rotating element 133 substantially disc-shaped, from which respective first jointed transfer arms 134 branch off, which in turn have, on a respective distal operating end thereof, a first gripping device 135 which may be of the suction-cup, gripper or mixed type.

The first gripping devices 135 therefore move with a closed trajectory around the first shaft 132 thereof: such a trajectory is the result of performing this revolution motion with a rotating motion, around a vertical axis, imparted by the respective first arm 134, required to transfer the content to be packaged to the proper target position on the shaping device 150.

The transfer from the inlet transport plane 120 to a subsequent shaping plane, which will be described hereinafter, is therefore carried out by moving the product to be packaged onto a single inlet transfer plane, which is arranged horizontally and which is, in particular, coplanar to the inlet transport plane 120.

In other words, the inlet transport plane 120 (FIG. 1A) and the transfer plane, being coplanar, identify a working plane 140, which is therefore common to both planes. The working plane 140 is a horizontal plane and, in the present disclosure, when reference is made to a vertical axis, it relates to an axis perpendicular to the working plane 140.

Furthermore, the above-described composition of the revolution and rotating motions, which carries out the transfer of the content to be packaged, produces a first curvilinear transfer path 136, which joins the unloading terminal end 122, of said first transport device 110, to a subsequent annular path, i.e. a path of the circular and closed type lying on said shaping plane, at a first insertion end 137, which belongs to said annular path.

As already mentioned, the apparatus 100 includes a shaping device 150, on which a box is shaped by an operation of wrapping around a blank, referred to as 200, around the content to be packaged.

The shaping device 150 consists of a substantially carousel structure in which the aforesaid annular path is defined, referred to as 160, lying on a shaping plane, on which one or more shaping supports 151 are conveyed, in particular a plurality thereof, which move in substantially continuous motion, remaining spaced apart from each other by a substantially constant spacing.

Each of the shaping supports 151 is arranged to receive a content to be packaged at said inlet end 137, and in this way the boxes are shaped by wrapping around said blank 200 onto each of said supports 151, while the latter, and thus the respective contents to be packaged, already deposited thereon by the inlet transfer device 130, move along said annular path 160.

In particular, the above-mentioned shaping plane corresponds to a trajectory extending, in said annular path 160, over a portion of said shaping portion 161, which in turn extends from said inlet end 137 to an outlet end 138, which will be described hereinafter.

Such a trajectory constitutes a box shaping path 162 in said shaping portion 161. The shaping path 162 lies entirely on a shaping plane in said annular path 160, which is therefore coplanar with the inlet transfer plane and the transport plane 120. All these planes, therefore, coincide with the working plane 140.

The apparatus 100 comprises a blank insertion device 170 which provides a respective blank 200 at a respective shaping support 151 in which the content to be packaged has been transferred.

The blank 200 insertion device 170 has a carousel structure: it comprises a respective second base 171, a respective second upright 172 extending vertically from said base 171 and having, at its top, a respective second rotating element 173 substantially disc-shaped, from which respective jointed insertion arms 174 branch off, which in turn have, on a respective distal operating end thereof, a blank pick-up and release device 175.

The insertion arms 174 comprise a jointed proximal end 176, which is connected to the second rotating element 173, and suitable movement members so that the arm 174 may protrude with an inclination that may be varied with respect to the radial direction.

Moreover, it may vary its extension by stretching and shortening, so that the planetary motion of each pick-up and release device 175 is complex and only approximately circular. The respective blank pick-up and release device 175 finally comprises special movement elements to rotate about a vertical axis.

The rotation of the rotating element 173 and the movements of the insertion arms 174 thereby make the pick-up and release devices 175 follow a closed path with deviations for picking up and releasing the blank 200.

In addition, the apparatus 100 comprises a device 180 for dispensing blanks, provided in a stack 181 of blanks 200 which is fed by a blank conveyor 182 suitably fed upstream.

In the stack 181, the blanks 200 are arranged in a substantially vertical position and show externally, at the end of the stack 181 proximal to the insertion device 170, a first blank surface which is intended to be the outer surface of a corresponding box.

The blank pick-up and release device 175 comprises a flat frame 177 comprising a number of gripping suction cups 178 adapted to adhere to said first surface of the blank. In this regard, the insertion arm 174 is capable of moving the pick-up and release device 175 closer to and away from the stack 181, relative to the main motion of the pick-up and release device 175 which is circular. In turn, as the blanks 120 are picked up, the stack 181 is translated in the direction of the insertion device 170 so that the position of the blank to be picked up is always approximately the same.

In the present embodiment, the flat frame 177 comprises four gripping suction cups 178 which adhere at a position corresponding to each of the corners of the blank 200, which is substantially rectangular in shape with some flaps protruding from the borders.

Once extracted from the stack 181, the blank is moved along an insertion path 201 extending from the stack 181 to a blank insertion area 139 in the shaping device 150, i.e. in the box shaping path 162.

The shape of the trajectory of the pick-up and release devices 175 along said insertion path 201 is curvilinear, only approximately circular, with a second surface of the blank opposite to said first surface, which is positioned on the extrados of the trajectory, in a vertical position.

The insertion device 170, at an intermediate position in the insertion path 201 between the blank stack 181 and the blank insertion area 139, thus comprises a deposition device 179 which deposits, on said second surface, at least one strip of adhesive material, positioned on a protruding flap of the blank 200, intended to be adhered to a wall of the box at the end of the shaping by wrapping-around, i.e. in the step of shaping and closing the box.

In particular, the protruding flap, on which the adhesive is deposited, is positioned along a margin which, looking at the vertical position in which the blank 200 is held in the pick-up and release device 175, is an upper margin of the blank 200, and consists of a folding flap adapted to be adhered to the inner surface of the blank 200, at an opposite margin which, looking at the vertical position in which the blank 200 is held in the pick-up and release device 175, is the lower margin.

It should also be noted that the blank has already been provided with main folding lines which, when looking at the vertical position in which the blank 200 is held in the pick-up and release device 175, extend in a horizontal direction.

At the insertion area 139, the pick-up and release device 175 follows a motion resulting from a combination of its rotation about a vertical axis, the inclination of the respective arm 174 with respect to a radial direction and an elongation of the arm itself, so that the blank 200 is inserted into the shaping path 162 with the two inner and outer surfaces of the blank substantially perpendicular to the trajectory of the shaping supports 151 at the insertion area 139.

It is understood that the passage of the shaping supports 151 and the insertion of the blanks 200 into the insertion area 139 is synchronised, so that the shaping support 151, with the content to be packaged on board, contacts the inner surface of the blank 200 substantially at a centreline area thereof, causing it to fold as it advances.

Once the two portions of the blank 200, which are adapted to form the two opposite walls of the box, have been knocked down to make them adhere to the shaping support 151, the semi-finished box and the content to be packaged enter a shaping area 163 of the shaping path 162.

In this embodiment of the apparatus 100, the shaping support 151 comprises an extractable wrapping-around mandrel 154 comprising abutment walls on which the box walls are adhered in a predetermined position, forming predetermined angles with the other box walls, in particular angles of 90°.

The content to be packaged is deposited inside the mandrel 154, where a compartment is formed to accommodate it, so that the box may be shaped by wrapping it around, leaving the opposite sides of the box top open.

Once the walls have been placed in their respective target positions, the flap on which the adhesive had been placed and a side wall are mated and pressed together, thus concluding this step of shaping by wrapping around, whereupon the wrapped box, with the content to be packaged therein, exits the shaping area 163.

By exploiting the ends of the box that are still open, the mandrel 154 may be extracted from the box, leaving the content to be packaged in place, before the box is transferred to an outlet transport plane. Once this extraction is complete, the box rests on the shaping support and ends up travelling the shaping path 162.

The packaging apparatus 100 comprises, at this point, a second transfer device 190 that acts as an outlet transfer device, to transfer the box from the shaping plane to an outlet transport plane, also arranged horizontally.

In fact, the second transfer device 190 is arranged to pick up a box, with the respective content to be packaged therein, which moves on the shaping plane, to transfer it from there to a second transport device 115, consisting of a rectilinear conveyor belt.

The second transport device 110 defines a respective outlet transport plane that coincides with the inlet transport plane 120 defined by the first transport device.

Thereby, the outlet transport plane is respectively coplanar with the inlet transport plane 120, the inlet transfer plane and the shaping plane, all of which therefore coincide with the working plane 140.

The second transport device 115 thus defines a trajectory, followed by each box, which constitutes an exit path 126, rectilinear and horizontally arranged (FIG. 3), of the wrapped-around box, with the content to be packaged inside it, starting from an inlet end 127.

The outlet shaping device 190 has a carousel structure: it comprises a third base 191, a third upright 192 extending vertically from said base 191 and comprising, on its top, a third rotating element 193 substantially disc-shaped, from which respective second jointed transfer arms 194 branch off, which in turn comprise, on a respective distal operating end thereof, a second gripping device 195 which may be of the suction cup, gripper, or mixed type.

The second gripping devices 195 therefore move with a closed trajectory around its own third shaft 192: such a trajectory is the result of performing this revolution motion with a rotating motion, about a vertical axis, imparted by the respective second transfer arm 194, required to transfer the box onto the outlet transport plane.

It should be noted that, in the present embodiment, the entry and exit transport planes are substantially parallel and consecutive, in order to obtain an elongated configuration of the apparatus 100, but it is understood that other configurations with different positions of the transport planes are possible.

The transfer from the shaping plane to the subsequent outlet transport plane is therefore carried out by moving the box on a single outlet transfer plane, which is arranged horizontally and is, in particular, coplanar to the outlet transport plane and the shaping plane.

In other words, the outlet transport plane (FIG. 1A) and the outlet transfer plane, being coplanar, coincide with said working plane 140, which is therefore common to these and the other planes.

Furthermore, the above-described composition of the revolution and rotating motions of the second gripping devices 195, which carries out the transfer of the box with the content to be packaged therein, produces a second curvilinear transfer path 128, which joins the outlet end 138 of the forming path 162 to the inlet end 127 of the exit path 126, on which said box received by the outlet transfer device is conveyed leaning thereon.

The outlet transfer device 190 thereby transfers the box by moving it on an outlet transfer plane, coplanar to said outlet transfer plane and shaping plane, along a curvilinear outlet transfer path.

Once released from its box, the shaping support continues its travel along the annular path 160 to return to the first insertion end 137, thus travelling along a return portion 164 of the annular path.

The shaping support 51 is made on a lift mechanism 153 that is made to revolve by the carousel shaping device 10, thus travelling the entire annular path 160.

The function of the lift mechanism 153 is to lower the height of the shaping support 151 and the mandrel 154, at the return portion 164, and to lift it at the insertion end 137 so that, when the shaping support 151 receives the respective content to be packaged from the first transfer device 130, it is lifted to a shaping level that corresponds to said shaping plane, i.e., the working plane, thereby reducing any form of stress on the content to be packaged which does not collide with or fall on the target area of the shaping support 151.

In addition, when the box is transferred to the outlet transfer device 190, the lift mechanism 153 lowers said shaping support to a lower level.

In other words, the shaping device 150 comprises a section, which corresponds to said return portion 164, in which the shaping support 151 follows a path in which, at the end of the shaping plane, it descends to a lower level and subsequently ascends again to the level of the shaping plane at its inlet, receiving said content to be packaged in the ascent.

In addition, during its ascent, the shaping support 151, which otherwise moves across the shaping plane at a predetermined and substantially constant shaping speed, is slowed down to mate with said content to be packaged.

This ensures that the transport from the inlet transfer plane to the shaping plane and from the shaping plane to the outlet transport plane takes place on the inlet transfer plane and the outlet transfer plan coplanar to said transport planes and shaping planes, all of which coincident with the working plane 140.

A person skilled in the art may make several further modifications and variations to the above-described apparatus and process for shaping a box by wrapping-around, in order to meet additional and contingent requirements, all of which fall, however, within the scope of protection of the present solution as defined by the attached claims.

1.-18. (canceled)

19. A process for shaping a box by wrapping around, comprising the steps of:
(a) conveying a content to be packaged on an inlet transport plane, said inlet transport plane arranged horizontally, the content to be packaged placed on said inlet transport plane;
(b) transferring the content to be packaged onto a shaping support, the shaping support continuously traveling along an annular path, the annular path comprising a shaping portion, the shaping support moving on a shaping plane at said shaping portion; and
(c) wrapping a blank around the content to be packaged while the shaping support is travelling on said shaping plane to form a box;
wherein the inlet transport plane and the shaping plane are coplanar with each other.

20. The process for shaping a box by wrapping around according to claim 19, further comprising after the wrapping:
(d) transferring the box and the content to be packaged therein onto an outlet transport plane, arranged horizontally, the box being placed on said outlet transport plane;
wherein the outlet transport plane and the shaping plane are coplanar with each other.

21. The process for shaping a box by wrapping around according to claim 19,
the process further comprising after the wrapping:
(e) descending said shaping support, at the end of said shaping plane, to a lower level, and
(f) ascending, during an ascent, the shaping support to a level of the shaping plane at an inlet of the shaping plane,
the transferring further comprising receiving said content to be packaged during the ascent, a transfer from the inlet transport plane to the shaping plane taking place on an inlet transfer plane coplanar to said inlet transport plane and to said shaping plane, and
wherein said annular path further comprises a return portion.

22. The process for shaping a box by wrapping around according to claim 21, wherein:
said shaping support moves on the shaping plane at a predetermined substantially constant shaping speed, and
at said ascent, a speed of the shaping support is slowed down for the shaping support to mate with said content to be packaged.

23. The process for shaping a box by wrapping around according to claim 22, wherein:
said inlet transport plane comprises an entry path, along which said content to be packaged moves, and
said inlet transfer plane comprises a first curvilinear transfer path, the first curvilinear transfer path joining a terminal end of said entry path to said annular path during the ascent of the shaping support.

24. The process for shaping a box by wrapping around according to claim 23, wherein said entry path is rectilinear.

25. The process for shaping a box by wrapping around according to claim 20, wherein, at a terminal end of said shaping plane, the transfer of the box with the content to be packaged therein to the outlet transport plane takes place on an outlet transfer plane which is coplanar with said shaping plane and outlet transport plane.

26. The process for shaping a box by wrapping around according to claim 25, wherein said outlet transport plane comprises an exit path along which said box with the content to be packaged inside it moves, and wherein said outlet transfer plane comprises a second curvilinear transfer path which joins a terminal end of said shaping path with said exit path.

27. The process for shaping a box by wrapping around according to claim 26, wherein said exit path is rectilinear.

28. The process for shaping a box by wrapping around according to claim 19, wherein said shaping support comprises a wrapping around mandrel.

29. An apparatus for shaping a box by wrapping around, comprising:
an inlet transport plane arranged horizontally, configured to convey a content to be packaged, the content leaning on the inlet transport plane,
an inlet transfer device, configured to transfer the content to be packaged from said inlet transport plane,
a shaping device comprising:
an annular path,
one or more shaping supports configured to continuously travel along the annular path, and
a shaping plane wherein one or more boxes are formed by wrapping around onto respective shaping supports of the one or more shaping supports configured to receive said content to be packaged from said inlet transfer device, and
a blank insertion device to provide respective blanks at the respective shaping supports in which said content to be packaged has been transferred,
wherein the inlet transport plane and the shaping plane are coplanar with each other.

30. The apparatus for shaping a box by wrapping around according to claim 29, further comprising:
an outlet transfer device for transferring a box obtained on the shaping plane, and
an outlet transport plane arranged horizontally, on which said box, received from the outlet transfer device, is conveyed leaning thereon,
wherein said shaping plane and said outlet transport plane are coplanar with each other.

31. The apparatus for shaping a box by wrapping around according to claim 29, wherein said annular path is formed substantially on a carousel structure, the carousel structure comprising a vertical axis of rotation.

32. The apparatus for shaping a box by wrapping around according to claim 31, wherein:
said one or more shaping supports are placed on a lift mechanism, the lift mechanism configured to:
revolve around,
raise said one or more shaping supports to a shaping level corresponding to said shaping plane when the one or more shaping supports receive the respective content to be packaged from said inlet transfer device, and
lower said one or more shaping supports to a lower level when a box is transferred outlet transfer device.

33. The apparatus for shaping a box by wrapping around according to claim 29, wherein the inlet transfer device is configured to transfer said content to be packaged by moving said content to be packaged on an inlet transfer plane along an inlet curvilinear transfer path, the inlet transfer plane being coplanar to said inlet transport plane and to said shaping plane.

34. The apparatus for shaping a box by wrapping around according to claim 30, wherein the outlet transfer device is configured to transfer said box by moving said box on an outlet transfer plane along an outlet curvilinear transfer path, the outlet transfer plane being coplanar to said outlet transport plane and to said shaping plane.

35. The apparatus for shaping a box by wrapping around according to claim 29, said one or more shaping supports comprising a wrapping around mandrel which is configured to be extracted from at least one open end of a box before a transfer of the box on said outlet transfer plane.

36. The apparatus for shaping a box by wrapping around according to claim 29, wherein said inlet transport plane is formed on an entry rectilinear conveyor belt and said outlet transport plane is formed on an exit rectilinear conveyor belt.
